(19) United States
(12) Patent Application Publication
(10) Pub. No.: US 2006/0230101 A1
(43) Pub. Date: Oct. 12, 2006

(54) Telecommunications system for diffusing a multimedia flux through a public communication network

(75) Inventors: Jean-Louis Marque, Montpellier (FR); Dominique Jezequel, Prat (FR); Emmanuel Le Huerou, Lannion (FR); Christophe Rouquie, Paris (FR)

Correspondence Address: LOWE HAUPTMAN BERNER, LLP, 1700 DIAGONAL ROAD, SUITE 300, ALEXANDRIA, VA, 22314, US

(73) Assignee: France Telecom SA, Paris (FR)

(21) Appl. No.: 10/546,274

(22) PCT Filed: Feb. 26, 2004
(86) PCT No.: PCT/FR04/00436

§ 371 Date: Aug. 19, 2005

(30) Foreign Application Priority Data
Feb. 28, 2003 (FR) 03/02666

(51) Int. Cl. G06F 15/16

(52) U.S. Cl. 709/203

(57) ABSTRACT

A telecommunication system has at least one conference bridge for transmitting at least one flow of stimuli to several active users. A data server receives data coming from at least one terminal. A compilation device (1) collects the flow of stimuli on the one hand and synchronisation information relating to data received by the data server on the other hand, and (2) generates signals representing the stimuli and the synchronization information for transmission of signals to at least one other terminal.

The present invention concerns a telecommunication system intended to allow several active users to exchange between them information represented by at least one flow of stimuli, the said system including at least one conference bridge able to process the said flow of stimuli.

Such communication systems are normally used for implementing teleconferences between a number of participants physically distant from one another. The flows of stimuli can for example consist of flows of sounds and, optionally, flows of images. In such an application, the conference bridge executes an adding of the various flows of sound emitted by the various users, and sends to each user a signal representing the result of this adding, from which the flow of sounds emitted by the user in question had previously been subtracted. The conference bridge will also be able to select at each moment a flow of images emitted by whichever user is speaking at the time in question, and to send the selected flow of images to the other users, thus performing an operation known to persons skilled in the art by the term “switching of images to voice”. Alternatively, the conference bridge would be able to recompose an overall image on the basis of the flows of images sent by all the active users in order to create an illusion of simultaneous presence of all these users at the same virtual place, thus performing an operation known to persons skilled in the art by the term “continuous presence simulation”.

There thus exists in the current state of the art telecommunication systems able to process physical systems, such as sounds or actions, sent by users of such systems. However, these physical systems sent by an active user may be enriched by data signals, for example text, graphics or any type of pre-recorded audio visual presentation, for the purpose of facilitating understanding of the conversations held by this user.

The conference bridges known from the prior art are not capable of by themselves processing such data signals, so that specific equipment must be provided for this purpose. A data server can be used for this purpose, which server will be able to collect data, via a communication network such as the Internet, from computer equipment used by the various active users of the telecommunication system described above. Such a server will be intended to store the data coming from the various active users and to make them accessible to the said active users during the teleconference for the purpose of which these data were generated. The data signals will in general be digital in nature since they will usually have been generated by computer equipment, of the personal computer or workstation type.

To allow broadcasting to a broad public of the knowledge disclosed during a teleconference, it is desirable to make accessible to passive users the flows of images, sounds and possibly data that are exchanged between active users connected to the conference bridge, the said passive users not themselves being directly connected to the conference bridge and therefore being unable to participate actively in these exchanges.

In the present state of the art, such a broadcasting cannot be achieved solely by means of the conference bridge, since the flows of information, in particular the image flows, which are intended to pass through the conference bridge, have a volume such that a small number of active participants suffices to entirely consume a bandwidth allocated to the transmission resources of the said conference bridge. A data service such as the one mentioned above for its part can be used only for broadcasting data ancillary to the actions of the various active users and cannot be used for broadcasting the flows of images and sound described above.

Moreover, the conference bridge effects a processing of the flows of images and sounds according to formats that are peculiar to it and are in principle not compatible with standardised data transmission protocols, so that only users connected together by such a conference bridge can have access to these flows.

One of the aims of the invention is to allow broadcasting, to a large number of passive users, of all the content of a conference in which the various active users are participating, the said content being represented by a flow of stimuli consisting for example of flows of sound, flows of data and optionally flows of images.

This is because a telecommunications system in accordance with the introductory paragraph is characterised according to the invention in that it includes, apart from the conference bridge:

a data server connected to at least one terminal made available to at least one of the said active users and able to receive data coming from the said terminal, and

a compilation device able to collect the said flow of stimuli processed by the conference bridge on the one hand and synchronisation information relating to data received by the data server on the other hand and to generate signals representing the said stimuli and the said synchronisation information with a view to a transmission of these signals to at least one other terminal distinct from the terminal or terminals made available to at least one of the said active users.

The invention allows a grouping of all the flows of information, and a transformation of the said flows into signals compatible with normal transmission means, such as for example the Internet. These signals can then easily be broadcast to a large number of passive users, without such a broadcasting interfering with the functioning of the conference bridge.

According to a particular embodiment of the invention, at least one terminal made available to an active user is able to generate control signals associated with data sent by the said active user, the conference bridge being able to convey the said control signals to at least one other terminal made available to another user.

The fact that the conference bridge is able to convey control signals, for example via a specific channel, will allow control at a distance, by the active user who is in the process of developing a talk, of terminals made available to the audience of the said active user. These control signals can constitute instructions or signal specific events occurring during the talk.

One or more communication channels will advantageously be provided between one or more terminals distinct from the terminal or terminals made available to at least one of the said active users and one or more of the said terminals made available to active users.

Such a communication channel will enable one or more passive users of a telecommunication system to transmit messages containing questions or observations to the active users. The passive users will thus be able to react to one or more talks of which they will firstly have been solely spectators, in order to obtain explanations on certain passages of the said talks, or in order to make comments which can only enhance the content of future talks. Such an arrangement of the system described above will thus confer a share of relative interactivity in the talks transmitted to the passive users, who will not have the possibility of participating in real time in the progress of the said talks. Such communication channels also make possible, between other complementary applications, consultations of opinion by means of on-line votes.

According to a variant of the invention, a telecommunication system as described above will also include storage means intended to store information conveyed by signals generated by the compilation device.

Such a variant of the invention will allow deferred transmission of a teleconference to passive users, but also to active users who participated in the said teleconference and might wish to relive it as whole, rather than solely from the point of view of a participant that would have been theirs during the progress of the conference recorded.

The characteristics of the invention mentioned above, as well as others, will emerge more clearly from a reading of the following description of an example embodiment, the said description being given in relation to the accompanying drawings, amongst which:

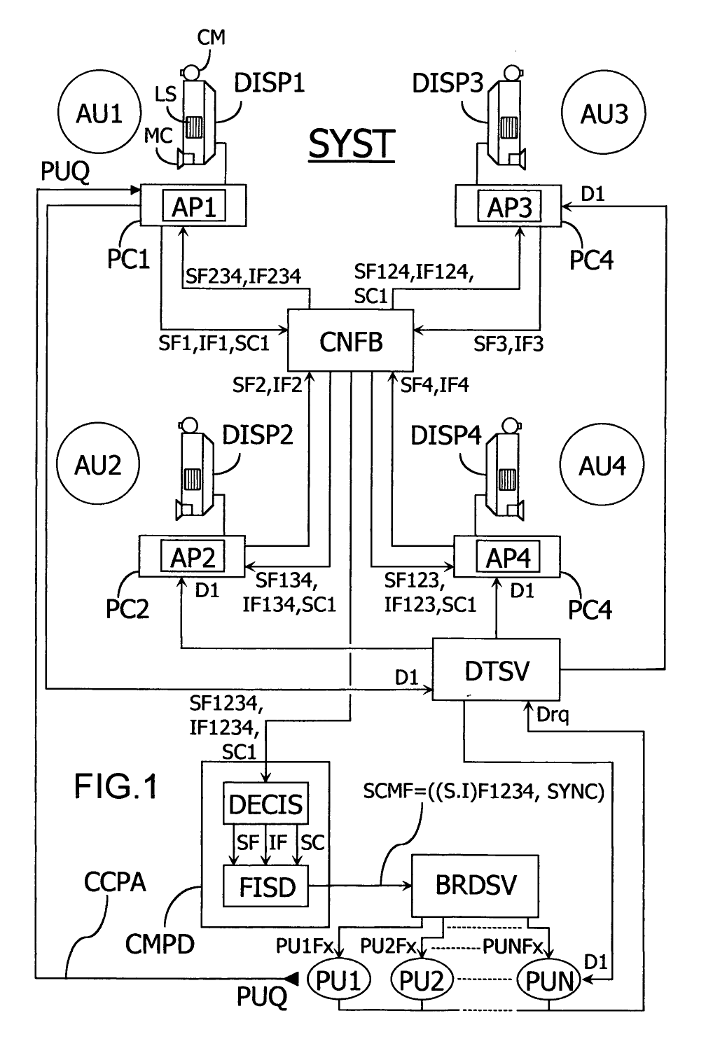

FIG. 1 is a functional diagram depicting a telecommunication system according to a particular embodiment of the invention,

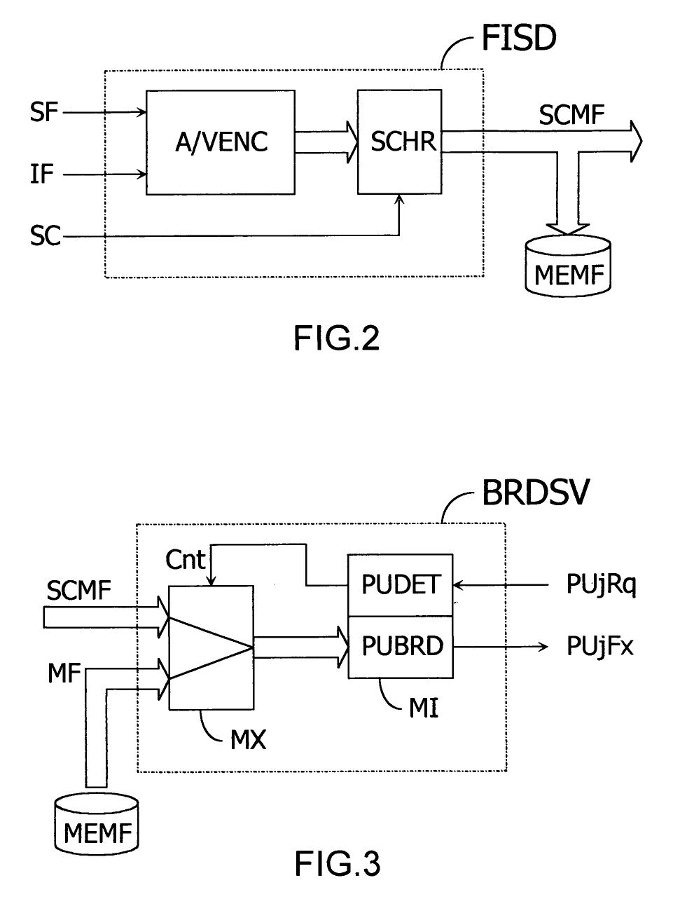

FIG. 2 is a functional diagram that depicts shaping means used in a compilation device included in such a telecommunication system, and

FIG. 3 is a functional diagram that depicts broadcasting means used in such a telecommunication system.

FIG. 1 depicts a telecommunication system SYST in which the invention is implemented. This system SYST is here intended to enable first, second, third and fourth active users AU1, AU2, AU3 and AU4 to exchange with each other flows of stimuli represented in this example by flows of images IFi attached to flows of sound SFi (for i=1 to 4).

Each active user AUi is here provided with a terminal including a display device DISPi, which is provided with at least one camera CM and at least one microphone MC respectively intended to generate the flows of images and sounds IFi and SFi intended for the other users of the system SYST. The display device DISPi consists of a screen intended to display flows of images intended for the active user AUi and at least one loudspeaker LS intended to restore flows of sound intended for the said active user AUi.

This system SYST includes a conference bridge CNFB able to process the said flows of images and sound IFi and SFi (for i=1 to 4). The conference bridge CNFB is here intended to execute, according to a technique known to persons skilled in the art, an adding of the different flows of sounds SFi (for i=1 to 4) sent by the various active users AUi, and thus to generate a resulting flow of sounds SF1234. The conference bridge CNFB is then able to send to each active user AUi (for i=1 to 4) a signal representing the resulting flow of sounds SF1234, from which the flow of sounds SFi sent by the active user AUi in question will previously have been subtracted. Thus the first active user AU1 will receive from the conference bridge a flow of sounds SF234 consisting of the resulting flow of sounds SF1234 from which the flow of sounds SF1 sent by the first active user AU1 himself will have been subtracted.

In a particular embodiment of the invention not depicted in the present figure, the conference bridge CNFB can be able to select at any time the flow of images sent by whichever of the active users is speaking at the time in question and to send the flow of images selected to the other active users, thus performing an operation known to persons skilled in the art by the term “switching of images to voice”.

In the particular embodiment of the invention described here, the conference bridge CNFB is able to recompose an overall flow of images IF1234 obtained on the basis of the flows of images IFi sent by all the active users AUi (for i=1 to 4) in order to create an illusion of simultaneous presence of all the active users at the same virtual place, thus performing an operation known to persons skilled in the art by the term “continuous presence simulation”. The conference bridge CNFB is then able to send to each active user AUi (for i=1 to 4) a signal representing the resulting flow of images IF1234, from which the flow of images IFi sent by the active user AUi in question will previously have been subtracted. Thus the second active user AU2 will receive from the conference bridge a flow of images IF134 consisting of the resulting flow of images IF1234 from which the flow of images IF2 sent by the second active user AU1 himself would have been subtracted.

Each terminal made available to an active user AUi includes in the example described here a personal computer PCi that will enable this active user to send, to the other users of the system, data signals, for example texts, graphics or any type of pre-recorded audio visual presentation, for the purpose of facilitating understanding of the talks given by this active user.

Conversely, the personal computer PCi with which each active user AUI is here provided will enable this active user to receive data signals from the other users of the system.

A local management of the flows of data coming from or intended for each active user AUi (for i=1 to 4) is achieved by means of a specific software application APi installed on the personal computer PCi of the said active user AUi.

In the example described here, the flows of images and sounds coming from or intended for each user AUi also pass via his personal computer PCi, which makes it possible to collect together in a single apparatus all the equipment locally necessary for each active user to participate in a teleconference carried out by means of a telecommunication system SYST according to the present invention. Such a collecting together of means is however purely optional and without any direct effect on the invention itself.

As disclosed above, the conference bridge CNFB is not capable of processing data flows by itself, so that dedicated equipment is provided for this purpose. A data server DTSV is used for this purpose, the said data server DTSV being able to collect such data flows, via a communication network such as the Internet, from the personal computers PCi with which the various active users AUi (for i=1 to 4) of the telecommunications system SYST are provided. In the example described here, only the first user AU1 sends data D1 that will be stored in the data server DTSV and retransmitted by the said server DTSV to the other active users AU2, AU3 and AU4 during the development by the first active user AU1 of the talk for the purpose of which these data were generated. The first active user AU1 will for example be able to be a teacher giving a course of three different classes which each constitute one of the second or third or fourth active user AU2, AU3 and AU4.

To allow broadcasting to a broad public of the knowledge disclosed during a teleconference, it is desirable to make accessible to passive users PU1, PU2 . . . PUN the flows of images, sounds and possibly data that are exchanged between the active users AUi (for i=1 to 4) connected to the conference bridge CNFB, the said passive users PUj (for j=1 to N) not being directly connected to the conference bridge CNFB and therefore in principle unable to participate actively in these exchanges.

Such a broadcasting to a broad public cannot be achieved solely by means of the conference bridge CNFB, since the flows of information (in particular the flows of images IFi that are intended to pass through the conference bridge CNFB, have a volume such that a small number of active participants AUi suffices to entirely consume a bandwidth allocated to the said conference bridge CNFB. Moreover, the conference bridge CNFB carries out a processing of the flows of images and sounds according to formats which are peculiar to it and are in principle not compatible with standardised data transmission protocols, for example the Internet protocol, so that, in the current state of the art, only users who are directly connected to the conference bridge CNFB can have access to the information flows passing through it.

In this embodiment of the invention, the system SYST includes a compilation device CMPD able to collect the flows of images and sounds processed by the conference bridge on the one hand and synchronisation information relating to data received by the data server DTSV on the other hand. The flows of images and sound IFi and SFi can be collected individually or, as is the case here, in the form of resulting flows IF1234 and SF1234 generated by the conference bridge CNFB. The data D1 collected from the data server DTSV already being in a form compatible with a transmission protocol dedicated to a public network, the said data will in principle not have to undergo specific decoding.

The compilation device CMPD includes decoding means DECIS for the said resulting flows of sounds and images SF1234 and IF1234 and shaping means FISD able to generate signals representing the said images, the said sounds and the said data with a view to transmission of these signals via broadcasting means BRDSV to terminals made available to N passive users PUj (for j=1 to N), which are distinct from the terminals made available to the active users AUi (for i=1 to 4).

The decoding means DECIS for this purpose separate the resulting flows of sounds and images SF1234 and IF1234, as well as the synchronisation information SC, into three distinct flows SF, IF and SC.

The shaping means FISD then generate media flows SCMF, which have been converted into a format compatible with a transmission protocol dedicated to a public network, for example into a Windowsmedia or Realnetworks format dedicated to broadcasting via the Internet (one or other of the aforementioned marks may be protected). The purpose of the media flows SCMF is to include the flows of images and sounds (S.I)F1234 generated by all the active users, the said flows of images and sounds being synchronised by means of synchronisation information SYNC issuing from the control signal SCI and relating to the data D1, sent by the first active user in support of his talk, with the said data D1.

The broadcasting means BRDSV will, possibly on request, supply to each terminal made available to a passive user PUj (for j=1 to N) flows PUjFx including images, sounds and synchronisation information and issuing from the media flows SCMF, which may have been previously stored.

In the embodiment of the invention described here, the terminal made available to the first active user AU1 is able to generate control signals SC1 associated with the data D1 sent by the said first active user AU 1. The conference bridge CNFB is able to convey these control signals SC1 to the terminals made available to the other active users AU2, AU3 and AU4 on the one hand but also to the terminals made available to the passive users PU1, PU2 . . . PUN.

Such a broadcasting of the control signals SC1, for example via a dedicated channel, will allow control at a distance, by the active user who is in the process of giving a talk, of terminals made available to the audience of the said active user. The terminals PU1, PU2 . . . PUN will for example, on an instruction transmitted by the control signals SC1 and represented by the synchronisation information SYNC, be able to request on the part of the data server DTSV and by means of requests Drq a supply of data D1 at pertinent moments defined by the said control signals SC1.

It should be noted here that the control signals SC1 can, in other embodiments of the invention, be broadcast by other channels and can in particular not pass over the conference bridge CNFB, being for example conveyed conjointly with the data signals D1.

In other configurations of the system SYST, not shown here in order not to unnecessarily complicate the description of the invention, the other active users AUi (for i=2 to 4) can also send data Di and control signals SCi that will be associated with them, with a view to a general or possibly selective broadcasting of the data Di and SCi to the terminals made available to the other users of the system SYST. The control signals SCi will be generated automatically by the applications APi intended to generate and send the data Di with which the control signals SCi are associated.

The control signals will be able to constitute instructions or indicate specific events arising during the talk.

Amongst various types of instructions possible, the control signal can include a command at a distance to launch or stop a given application, such as an Internet browser, a calculator, word processing software or a graphics presentation software, etc. The control signal can also include a command at a distance to move a window associated with an application to specific coordinates of a screen of the terminal for which such an instruction is intended, and a width and/or height of such a window.

The control signal can also include an activation command to the screen of an application previously placed in the menu of the “task bar” type. The control signal can also order execution of a function of an object “menu” or an object of the “button” type of any application previously installed on the terminal for which such an instruction is intended.

Amongst various types of events possible, the control signal will be able to indicate a synchronisation request for any Web page. Control signal can also indicate a request for synchronisation of the display of a graphic extracted from the data server, which request will have been made by an active user originating the said graphic by an action on a key on a keyboard or by clicking on a mouse. The control signal can also indicate a request to synchronise an animation of such a graphic, which request will also have been made by an action on a key of a keyboard or by clicking on a mouse.

Moreover, the system SYST described in this example embodiment of the invention includes a communication channel CCPA between the terminals made available to the passive users PU1, PU2 . . . PUN and the terminals made available to the active users, only the communication channel intended for the first active user AU1 being shown here in order to limit the complexity of the present figure.

Such a communication channel CCPA will enable one or more passive users PU1, PU2 . . . PUN to transmit messages PUQ containing questions or observations to the active users. The passive users PU1, PU2 . . . PUN will thus be able to react in real time or in a deferred manner to one or more talks for which they were initially only spectators, in order to obtain clarification on certain passages of the said talks, or in order to make comments that will enhance the content of future talks. The communication channel CCPA also allows, between other complementary applications, votes on line.

FIG. 2 illustrates schematically how shaping means FISD included in the compilation device previously described can be implemented. These shaping means FISD are intended to receive flows of sounds and images SF and IF as well as previously decoded control signals SC. An audio/video encoding module A/VENC is intended to encode the said flow of sounds and images in a format compatible with a transmission protocol via the Internet, for example in a Windowsmedia or Realnetworks format. The content of the control signals SC is integrated in the flow of sounds and images thus encoded by a synchronisation module SCHR intended to deliver flows SCMF in real time to the broadcasting means on the one hand but also to storage means that will allow broadcasting of these flows in deferred mode.

FIG. 3 illustrates schematically how broadcasting means BRDSV can be implemented. These broadcasting means BRDSV include switching means MX, for example a multiplexer, intended to receive either flows SCMF produced in real time by the compilation device or flows MF previously stored with a view to their broadcasting in deferred mode. The broadcasting means BRDSV also include an interface module MI comprising on the one hand a passive user detector PUDET and on the other hand a flow transmitter PUBRD. The passive user detector PUDET is intended to receive flow requests PUjRq sent by passive users PUj (for j=1 to N), each user PUj identifying, by means of such a request PUjRq, technical characteristics peculiar to the terminal that is available to it and the nature of the information flow that it wishes to receive, namely information produced in real time or in deferred mode. The passive user detector PUDET will send a control signal Cnt having in this example a binary value “0” or “1” that will indicate to the switching means MX whether it must select flows SCMF produced in real time or flows MF previously stored with a view to their transmission to the flow sender PUBRD, which will restore flows PUjFx specifically adapted to the technical characteristics defined by the passive user PUj in his request PUjRq.

1. Telecommunication system for enabling several active users to exchange with each other information represented by at least one flow of stimuli, the system including:
at least one conference bridge for processing the flow of stimuli,
a data server coupled to at least one terminal made available to at least one of the said active users for receiving data from the terminal, and
a compilation device for collecting the flow of stimuli processed by the conference bridge on the one hand and information relating to data received by the data server on the other hand and for generating signals representing the stimuli and the synchronization information for enabling transmission of these signals to at least one other terminal distinct from the terminal or terminals made available to at least one of the said active users.

2. Telecommunication system according to claim 1, wherein at least one terminal made available to an active user is arranged to generate control signals associated with data sent by the active user, the conference bridge being arranged to convey the control signals to at least one other terminal made available to another user.

3. Telecommunication system according to claim 2, including at least one communication channel between a terminal distinct from the terminal or terminals made available to at least one of the active users and at least one terminal made available to an active user.

4. Telecommunication system according to claim 3, further including a storage arrangement for storing information conveyed by signals generated by the compilation device.

5. Telecommunication system according to claim 1, including at least one communication channel between a terminal distinct from the terminal or terminals made available to at least one of the active users and at least one terminal made available to an active user.

6. Telecommunication system according to claim 2, further including a storage arrangement for storing information conveyed by signals generated by the compilation device.

7. Telecommunication system according to claim 1, further including a storage arrangement for storing information conveyed by signals generated by the compilation device.
